(19) United States
(12) Patent Application Publication
(10) Pub. No.: US 2019/0206002 A1
(43) Pub. Date: Jul. 4, 2019

(54) SYSTEMS, METHODS, AND DEVICES FOR FACILITATING PROPERTY BASED TRANSACTIONS

(71) Applicant: Ankur Gupta, Gurugram (IN)

(72) Inventor: Ankur Gupta, Gurugram (IN)

(21) Appl. No.: 16/320,923

(22) PCT Filed: Sep. 27, 2017
(86) PCT No.: PCT/IN2017/050430

§ 371 Date: Jan. 25, 2019

(30) Foreign Application Priority Data
Sep. 28, 2016 (IN) 201611033044

(51) Int. Cl. G06Q 50/16; G06Q 10/10; G06Q 40/02; G06Q 20/36

(52) U.S. Cl. CPC G06Q 50/163; G06Q 10/1095; G06Q 2220/00; G06Q 20/3678; G06Q 40/025

(57) ABSTRACT

System and method for facilitating property based transactions include profiling of the viewing user to identify authenticity, listing multiple properties, drawing a freehand parameter contour on a property map displayed to the user, automatically generating a geofence for the freehand parameter contour based on geographical location and popping a plurality of geofence properties based on tagging with a related address data field of listed said plurality of properties, requesting to book transaction engine in the server that is adapted to create in a virtual room to which at least one user device gains access for trading the one or more properties. Particularly, one or more bids includes computing and executing a valid higher bid for a forward auction, a lower bid of choice for a reverse auction, or an instant bid in real time.

### FIELD OF THE INVENTION

Embodiments of the present invention relate to systems and methods facilitating transactions between multiple parties, such as real estate transactions. More particularly, to communication on handheld devices, and more specifically, but not exclusively to facilitate property based transactions on mobile devices.

### BACKGROUND OF THE INVENTION

In the internet era, the overall dynamics of doing and running a business has changed drastically. Over the years, the internet has increasingly become the mechanism of choice for both consumers and different types of businesses for easy communication and facilitation of business transactions across the globe.

Earlier consumers used to search details of property in newspapers where advertisements were printed for rental, lease or to buy or sell property. However, due to advent of internet era more consumers use internet as a communication means to search for prospective buyer and seller of property. Currently, the real estate industry is at the mercy of property dealers, which results in multiple hassles for the end users as property dealers mostly list fake listings without any verification across different platforms.

The real estate based websites provide real time property searches based on a set of input search criteria provided by the user of the website. However, the search results many a times are not authentic and provide property details which are not available or sold out. These websites function as client development tools for real estate agents. The real estate agents gather information of the consumers visiting the property listing on the website and contact them but they don't provide accurate price details, location of the property and other property related information which the consumer is seeking from the real estate agent. Further, there is no meaningful interaction between a buyer and an individual agent. Recently, the real estate websites have a separate link for frequently asked questions and general information about residential, commercial, agricultural land which relates to details of real estate buying, selling or leasing. However, currently no automated method exists that allows buyers to access accurate real estate information while further providing an automated ability to ascertain genuine buyer and seller.

There exist a trend of auctioning real estate properties. Generally, real estate auctions occur in person and happen in cities where the properties are located. The real estate auctions are initiated by lending institution where the buyer fails to pay the loan amount of the property. However, in case of emergency where the seller is keen to sell the property urgently won't be possible in the current scenario as it is quite difficult to provide adequate notice to all the buyers that may wish to submit a bid. Particularly, in a standard method of selling real estate the highest bidder wins the auction no matter what the price he quotes. Therefore, there remains a risk of quoting undesirable low price for the property.

It is well known fact, that complex transactions often involve multiple parties in a process of auction and counter-offer to establish a transfer of rights which may be in the form of ownership, renting of property or lease in exchange for financial consideration. It is very important from a buyer's perspective to analyse a number of variables associated with the property transaction in question.

United States Patent Application 20170178262 titled “System for promoting and managing properties under judicial auction” is filed by SISTEMIA S.P.A. The patent discloses a management system for real estate judicial auctions providing real-time digital certification, with regard to the on-site inspections carried out by the involved subjects on a certain date.

U.S. Pat. No. 5,905,975 titled “Computer implemented methods and apparatus for auctions” is filed by Lawrence. The patent discloses a computer implemented system and method of executing an auction. The system has two intelligent systems, one for the auctioneer and the other one for a user. The auction is conducted by the auctioneer's system communications with the user system(s).

United States Patent Application 20110204142, titled “System and method of integrated National citizen identity management and e-governance” filed by Rao. The invention relates to an integrated system and method of secure national citizen identity management and e-Governance using the foundational platform and a centralized national-level electronic database of all citizens known as the National Registry (NR) or Central Data Repository (CDR).

However, none of the prior arts provide fair valuation of the real estate properties and a transparent mechanism to sell, buy or lease a real estate property in a locality. Further, there remains a need in the art to provide systems and methods related to buying and selling services under normal auction and bidding model with significant improvements over prior arts, and leasing services under reverse auction bidding model with significant improvements over prior arts. Accordingly, there remains a need in this disorganised sector to develop systems and methods to facilitate real estate transactions on fair and transparent terms to parties involved in the transaction. Accordingly, the present invention relates to systems and methods to facilitate real estate property based transactions based on numerous parameters.

### SUMMARY OF THE INVENTION

Embodiments of the present disclosure relates to real estate property based transactions methods, systems, and devices. In one embodiment, the present invention disclose a method for facilitating property based transactions including the steps of requesting by a user device, a web page from a server for display to a viewing user, profiling of the viewing user to identify authenticity of the viewing user and the viewing user connected to a number of other users via a communication network, listing of a plurality of properties for the property based transactions based on a plurality of property verification parameters, drawing a freehand parameter contour on a property map displayed to the viewing user, by the user device, automatically generating a geofence for the freehand parameter contour based on geographical location and popping a plurality of geofence properties based on tagging with a related address data field of listed the plurality of properties, requesting, by the user device, information from the server based on a plurality of property parameters to create an interface to view the listing of the plurality of geofence properties, retrieving the plurality of properties based on the plurality of property parameters, determining as to whether the plurality of properties match the information requested by the user device, selecting at least one property from the plurality of properties by the user device and legal verification of the selected at least one property by receiving portions of a document image in an electronic form retrieved from a document database of the server, requesting, by the user device, to schedule site visit of the selected at least one property, determining as to whether site visit of the selected at least one property feasible based on a plurality of site visit parameters, and the user can view the property documents. Further, requesting, by the user device, to book transaction engine in the server that is adapted to create in an encrypted virtual room to which at least one user device gains access for trading on the selected at least one property via the interface. Particularly, at least one bid includes the step of computing and executing a valid higher bid for a forward auction, a lower bid of choice for a reverse auction, or an instant bid in real time that is within a number of programmed bid parameters, if a competitive bid has been made and accepted by the auction site that is higher for the forward auction or lower for the reverse auction than the most recent bid determined by one or more bidding virtual agent.

In accordance with one aspect of the present invention, the present method includes the steps of determining as to whether the user is interested in facilitating the property based transaction, generating a contract agreement automatically based on user selection, paying upfront transaction amount as earnest money deposit (EMD), aggregating a plurality of loan offers to be provided to the user for the property based transaction and/or title insurance for the property based transaction. Particularly, the earnest money deposit (EMD) is the security amount so that none of the users can go back from their commitments post winning or losing the transaction deal. Moreover, this amount may be taken as part of brokerage or professional fees at a later stage. Further, the user is refunded the earnest money deposit (EMD) in case they don't win the bid by the implementation of the present method.

In one embodiment, the title insurance, deal closing and escrow process attempts to make even the most complex transaction fit this ideal model where nothing is released to any party of the transaction until all obligations of all parties have been fulfilled.

In accordance with one aspect of the present invention, the present method further includes the step of receiving the reverse auction request for leasing the selected one or more property from the user device includes receiving from the user device, geographical location information of a destination location for the reverse auction request for leasing the selected at least one property, transmitting the reverse auction request for leasing the selected at least one property, receiving bids in response to the reverse auction request for leasing the selected at least one property; and transmitting the bids to a lessor of the selected at least one property to a lessor communication device.

Embodiments of the present disclosure disclose, a system for facilitating property based transactions and preloading the property content performed by an apparatus for displaying a plurality of property content on a local handheld device, the system includes: a display unit, a preloading controller, and a preloading performing unit, including a display region of the plurality of properties. In operation, the displaying of the web content is performed by the display unit with preloading an application in a memory of a mobile computing device based on data stored in a remote server, one or more processors, and one or more computer-readable media having stored thereon instructions that are executable by the one or more processors to configure the system to display the plurality of properties, including instructions that are executable to configure the system to perform at least the following: profiling of the viewing user to identify authenticity of the viewing user and the viewing user connected to a plurality of other users via a communication network, listing of a plurality of properties for the property based transactions based on multiple property verification parameters, drawing a freehand parameter contour on a property map displayed to the viewing user, by the user device, automatically generating a geofence for the freehand parameter contour based on geographical location and popping a plurality of geofence properties based on tagging with a related address data field of listed the plurality of properties, requesting, by the user device, information from the server based on a plurality of property parameters to create an interface to view the listing of the plurality of geofence properties, retrieving the plurality of properties based on the plurality of property parameters, determining as to whether the plurality of properties match the information requested by the user device, selecting at least one property from the plurality of properties by the user device and legal verification of the selected at least one property by receiving portions of a document image in an electronic form retrieved from a document database of the server. Requesting, by the user device, to schedule site visit of the selected at least one property, determining as to whether site visit of the selected at least one property feasible based on a plurality of site visit parameters, requesting, by the user device, to book a transaction engine in the server that is adapted to create in an encrypted virtual room to which at least one user device gains access for trading on the selected at least one property via the interface, wherein at least one bid comprises computing and executing a valid higher bid for a forward auction, a lower bid of choice for a reverse auction, or an instant bid in real time that is within a programmed bid parameters, if a competitive bid has been made and accepted by the auction site that is higher for the forward auction or lower for the reverse auction than the most recent bid determined by at least one bidding virtual agent.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustration of an exemplary computer system within which various aspects of the disclosure can be implemented, according to one or more embodiments of the present invention;

FIG. 2 is the example system that can be used in implementations of the present disclosure, according to one embodiment of the present invention;

FIG. 3 is an example environment for property based transactions between one or more users, according to one embodiment of the present invention;

FIG. 4 is a flow diagram illustrating a method of facilitating property based transactions, according to one embodiment of the present invention;

FIG. 5 is a flow diagram illustrating a method of facilitating the property based transaction, according to further embodiment of the present invention;

FIG. 6 is a flow diagram depicting a method of facilitating reverse auction of one or more selected properties, according to one embodiment of the present invention;

FIG. 7 is a flow diagram illustrating a method for drawing a freehand parameter contour on a property map displayed to the viewing user, according to one embodiment of the present invention;

FIG. 8 is a flow diagram illustrating a method of property swap & exchange of one or more properties to the viewing user, according to one embodiment of the present invention; and

FIG. 9 is a flowchart illustrating a method for facilitating property based transactions, according to one embodiment of the present invention.

### DETAILED DESCRIPTION OF THE INVENTION

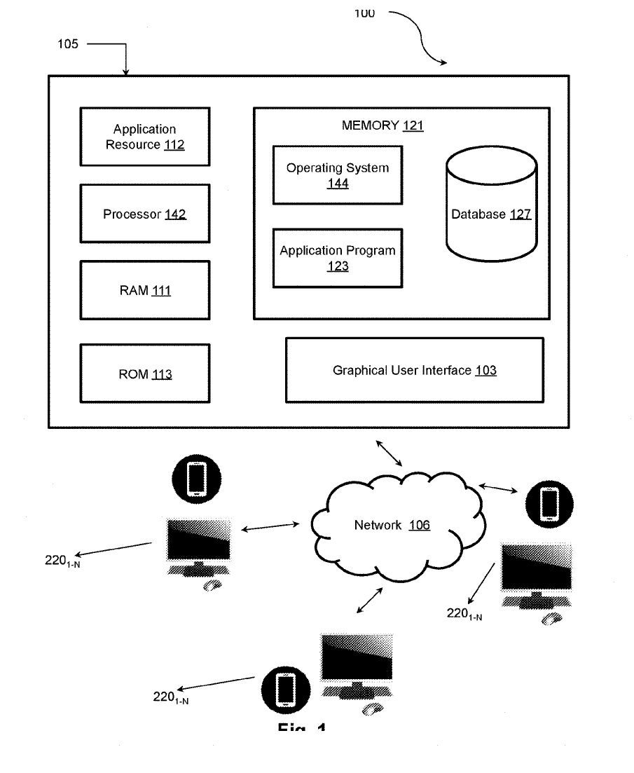

The principles of the present invention and their advantages are best understood by referring to FIG. 1 to FIG. 9. In the following detailed description of illustrative or exemplary embodiments of the disclosure, specific embodiments in which the disclosure may be practiced are described in sufficient detail to enable those skilled in the art to practice the disclosed embodiments. For example, specific details such as specific method steps, structures, elements, and connections are presented herein. However, it is to be understood that the specific details presented need not be utilized to practice the embodiments of the present disclosure.

The following detailed description is, therefore, not to be taken in a limiting sense, and the scope of the present disclosure is defined by the appended claims and equivalents thereof. References within the specification to “one embodiment,” “an embodiment,” “embodiments,” or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments but not other embodiments.

While there has been shown and described the preferred embodiment of the instant invention it is to be appreciated that the invention may be embodied otherwise than is herein specifically shown and described and that, within the embodiment, certain changes may be made in the form and arrangement of the parts without departing from the underlying ideas or principles of this invention as set forth in the Claims appended herewith. Therefore, the appended claims are to be construed to cover all equivalents falling within the true scope and spirit of the invention.

Residential properties refers to properties including apartments, residential land, independent house/villa, builder floor, studio apartments, service apartments and the like.

Commercial properties refers to properties including office space, shop, commercial land, institutional land, commercial showrooms, industrial and, industrial plots, factory, warehouses, office in IT park, hotels/resorts, guest house, banquet hall, space in retail malls, office in business park, SEZ space, business centre, cold storage, manufacturing. Others would include agricultural lands, farm lands, farm houses, school lands, hospitals, smart city govt project and housing for all 2022 govt policies and the like.

FIG. 1 is a block diagram illustration of an exemplary computer system 100 within which various aspects of the disclosure can be implemented, according to one or more embodiments of the present invention of property based transactions. With reference now to the figures, particularly like reference numbers denote like parts, FIG. 1 illustrates a typical hardware configuration of a computer processing system 100. As illustrated therein, various embodiments of the present invention may be embodied for buyers, sellers, lessors and lessees. In addition, certain embodiments may further be embodied for brokers to facilitate the real estate transactions. In accordance with an embodiment of the present invention, the system 100 for facilitating real estate transactions, includes, a central computing device 105 capable of communicating with users over a communication network 106. In accordance with an embodiment of the present invention, the computing device 105 may be similar to any available computing device, such as a personal computer (e.g., a desktop computer), server, laptop computer, notebook, tablet, smartphone, etc. The computing device 105 may have an application resource 112. Moreover, the computing device 105 may have the other modules and interfaces as discussed above for performing methods and executing instructions described above.

The one or more modules and interfaces explained above may be implemented with one or more processors and one or more storage units (e.g., databases 127, RAM 111, ROM 113, and other computer-readable media), one or more application specific integrated circuits (ASICs), and/or other hardware components. The one or more processors of the application resource 112 may operate in addition to or in conjunction with another general processor 142 of the computing device 105. Both application resource 112 and the processor 142 may be capable of controlling operations of the computing device 105 and its associated components, including RAM 111, ROM 113, the graphical user interface 103, and memory 121. The memory 121 may be any computer readable medium for storing computer executable instructions (e.g., software). The instructions stored within memory 121 may enable the computing device 105 to perform various functions. For example, memory 121 may store software used by the computing device 105, such as an operating system 144 and application programs 123, and may include a database 127. The graphical user interface 103 allows the computing device 105 to connect to and communicate with the network 106.

Particularly, the network 106 may be any type of network, including a local area network (LAN) and/or a wide area network (WAN), such as the Internet, a cellular network, or satellite network. Through the network 106, the computing device 105 may communicate with one or more devices, such as, for example, but not limited, laptops, notebooks, smartphones, personal computers, servers, etc. The devices may also be configured in a similar manner as computing device 105. In some embodiments the computing device 105 may be connected to other devices to form a “cloud” computing environment. In one embodiment, the computing device 105 includes one or more central processors 142 configured to execute multiple instructions, including, all the steps of methods in accordance with multiple embodiments of the present invention.

In some implementations, the system 100 can be a distributed client/server system that spans one or more networks such as the network 106. The network 106 can be a large computer network, such as a local area network (LAN), wide area network (WAN), the Internet, a cellular network, or a combination thereof connecting any number of mobile clients, fixed clients, and servers.

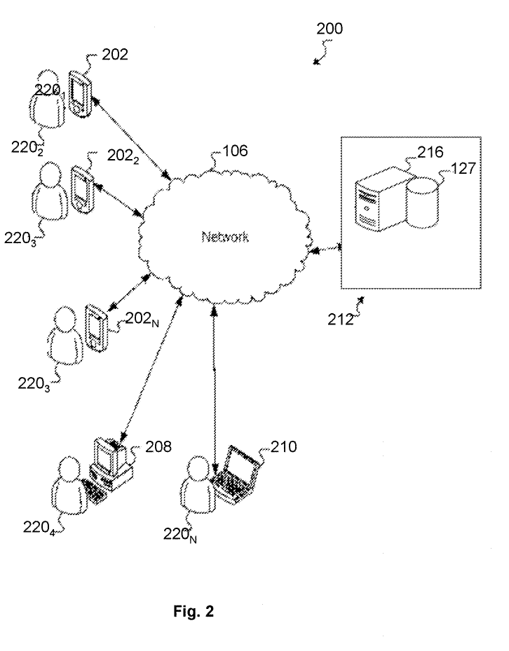

In some implementations, each client (e.g., computing devices 202₁ . . . 202_{N}, 208, 210) can communicate with servers (e.g., computing device 216) via a virtual private network (VPN), Secure Shell (SSH) tunnel, or other secure network connection as illustrated in FIG. 2 in accordance with embodiments of the present invention. In some implementations, the network 106 further include a corporate network (e.g., internet) and one or more wireless access points.

FIG. 2 depicts an example system 200 that can be used in implementations of the present disclosure. The example system 200 includes a plurality of client computing devices 202₁, 202₂, 202_{N}, 208, 210 each of the computing devices being associated with one of users 220₁-220ₙ.

The system 200 also includes a network 106, and a computing system 212 (server). The computing devices 202₁, 202₂, 202_{N}, 208, 210 and the computing system 212 can communicate with each other through the network 106. The computing system 212 can include one or more computing devices 216 (e.g., one or more servers 212) and one or more computer-readable storage devices (e.g., one or more databases 127). Each of computing devices 202₁, 202₂, 202_{N}, 208, 210 can represent various forms of processing devices. Example processing devices can include a desktop computer, a laptop computer, a handheld computer, a tablet computer, a personal digital assistant (PDA), a cellular telephone, a network appliance, a camera, a smartphone, an enhanced general packet radio service (EGPRS) mobile phone, a media player, a navigation device, an email device, a game console, or a combination of any these data processing devices or other data processing devices.

The computing devices 202₁, 202₂, 202_{N}, 208, 210 and 216 can be provided access to and/or receive application software executed and/or stored on any of the other computing systems 202₁, 202₂, 202_{N}, 208, 210 and 216. The computing device 216 can represent various forms of servers including, but not limited to a web server, an application server, a proxy server, a network server, or a server farm.

In some examples, the computing device 216 performs functions of a social network server. In some implementations, the computing devices 202₁, 202₂ . . . 202_{N}, 208, 210 and 216 can communicate wirelessly through a communication interface (not shown), which may include digital signal processing circuitry where necessary. The communication interface can provide for property information based on a user location of under various modes or protocols, AM signal, an FM signal, a phase modulated signal, CDMA, TDMA, spread spectrum, the Internet, a WFi connection, a Bluetooth connection, a Zigbee connection, a network, a wireless network, a 3G network, a 4G network, 5G, 6G, 7G, a USB connection, or any combination thereof. In addition, short-range communication may occur, such as using a Bluetooth, WiFi, or other such transceiver.

Furthermore in some embodiments, receiving the communication network relay related transmissions as using protocols including 3G protocols, 4G protocols, 5G protocols, 6G or 7G protocols module, when executed and/or activated, can direct performance of and/or perform the set of operations of the present method. Illustratively, in one or more implementations, the operation can be carried out, for example, by receiving the one or more communication network relay related transmissions from one or more electronic communication devices as heterogeneous types (e.g. mixtures of laptops, phablets, smartphones, etc.) receiving the one or more communication network relay related transmissions as using protocols (e.g. IEEE 802 protocols used together by intermediate electronic communication devices, etc.) including one or more 3G protocols, one or more 4G protocols, one or more 5G protocols, one or more 6G or one or more 7G protocols.

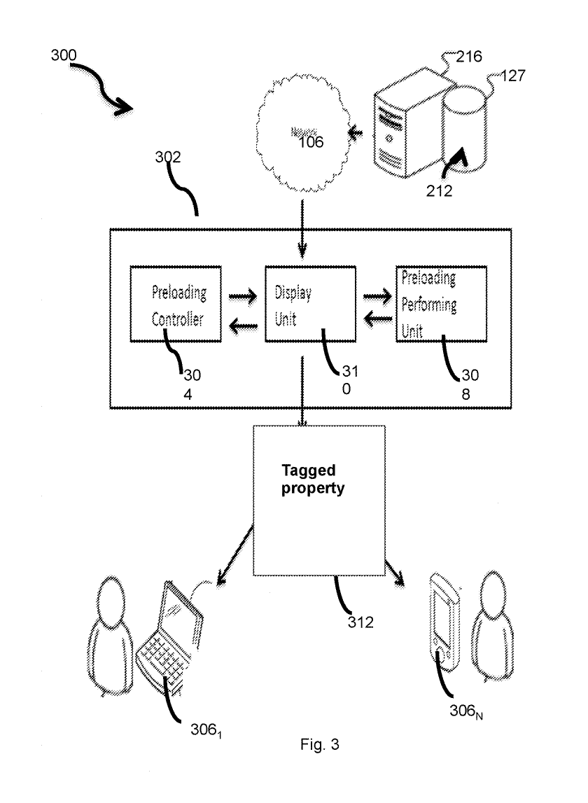

FIG. 3 depicts an example environment 300 for tagged property cross-referencing based on displaying one or more tagged property by a remote server 212 on the display unit system 302. The display unit system 302 can be implemented, for example, using one or more computing systems (e.g., the computing system 212 of FIG. 2). By way of a non-limiting example, multiple properties are displayed on the application launch icon in a launch area of a display of the mobile computing device 306₁₋ₙ However, the computing system 302₁, 302₂, . . . 302_{N}, 308 and 310 and mobile computing device 306_{1-N} numbering are used interchangeably for convenience.

The example environment 300 includes the system which includes a display unit 302, a preloading controller 304, and a preloading performing unit 308 and displaying is performed by the display unit 302 with a preloading an application in a memory of a mobile computing device based on data stored in a remote server 212 and displays the multiple properties 312 it on the mobile computing device 306_{1-N}.

The mobile computing device 306₁₋ₙ connect to the remote server 106 and the remote server 212 provides profiling of the viewing user, automatically generating the geofence for the freehand parameter contour based on geographical location and popping a plurality of geofence properties based on tagging with a related address data field of listed multiple properties, information from the server based on multiple property parameters. The location determining is performed by said preloading controller 304 and downloading is performed by the preloading performing unit 308 by receiving input from the server 212. The server 212 provides the input from the user regarding application launch. At the mobile computing device 306₁₋ₙ determining the location of the wireless device by obtaining and receiving locating signals by the wireless device.

In one embodiment, via the user device, the user 220₁-220_{N} is able to book a transaction engine in the server that is adapted to create in the encrypted virtual room to which at least one user device 202₁, 202₂, 202_{N}, 208, 210 gains access for trading on the selected one or more property via the interface. Particularly, one or more bids include computing and executing a valid higher bid for a forward auction, a lower bid of choice for a reverse auction, or an instant bid in real time that is within a programmed bid parameters, if a competitive bid has been made and accepted by the auction site that is higher for the forward auction or lower for the reverse auction than the most recent bid determined by at least one bidding virtual agent.

In one embodiment, particularly in instant bid the two participants namely buyer/seller or lessee/lessor can meet each other via the user device 202₁, 202₂, 202_{N}, 208, 210 where they can decide the pricing to come on a conclusion. Particularly, the price may go up or down depending on the scenario, and virtually it can be presumed that the present scenario is like one to one meeting for user clients.

In one embodiment, the at least one bid includes computing and executing a valid higher bid for the forward auction. A set of instructions are executed for providing the at least one bid by the buyer or lessor and progress bar to be updated as time progress in real time, wherein the buyer or lessor is able to view a current max bid, a highest bid by each buyer or lessor, and previous bidding bid status.

In yet another embodiment, the one or more processors and one or more computer-readable media having stored thereon instructions that are executable by the one or more processors to configure the system to display the multiple properties, including instructions that are executable to configure the system to perform profiling of the viewing user to identify authenticity of the viewing user includes the steps of providing a dashboard with one or more dashboard items, reviewing a contract retrieved from the server on the user device 202₁, 202₂, 202_{N}, 208, 210 identifying type of registration, and providing authenticity documents for verification of the viewing user and storing the authenticity documents in the database 127.

In one embodiment, the one or more dashboard items include details related to buyer, seller, lessor, lessee and operations details related to the execution of the present method are presented to the user device 202₁, 202₂, 202_{N}, 208, 210.

As illustrated therein, various embodiments of the present invention may be embodied for buyers, sellers, lessors and lessees. In accordance with an embodiment of the present invention, the system 100 for facilitating real estate transactions.

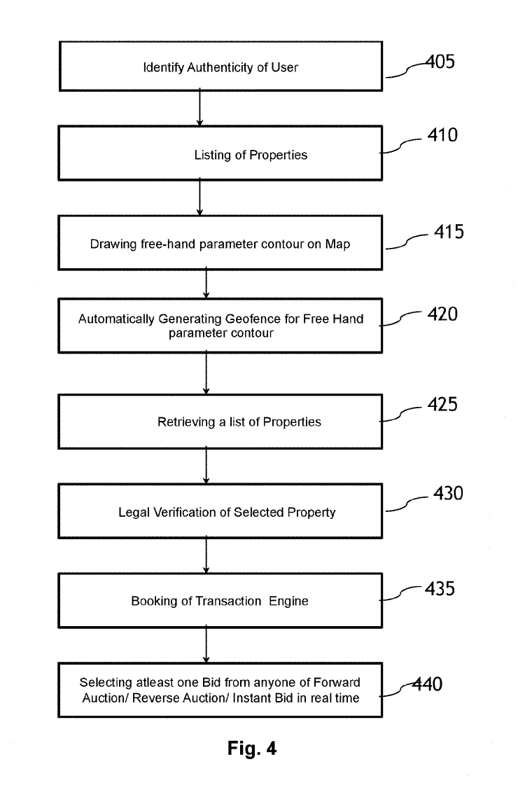

FIG. 4 is a flow diagram 400 of a method of facilitating property based transactions, according to one embodiment of the present invention. The method 400 starts at step 405 and proceeds to step 410. At step 405, the profiling of the viewing user 220_{1-N} is performed by executing a set of instructions to identify authenticity of the viewing user 220_{1-N}. Particularly, the one or more viewing users 220_{1-N} are connected to one or more other users 220_{1-N} via the communication network 214. To improve the relevance of the present system 100 and method, real estate transaction applications may rely upon the profile of the user 220_{1-N}. The user profiling information assist application services provide personalized content to the multiple users 220_{1-N}. The user profile may be created based on the one or more user particulars. Particularly, the user 220_{1-N} is required to select the nationality. The user 220_{1-N} can be an Indian resident, Non-Resident Indian (NRI), Overseas Citizen of India (OCI) or Person of Indian Origin (PIO).

In one embodiment, when the user 220_{1-N} is Indian resident then the user 220_{1-N} is required to upload PAN card and aadhar card to the server 212 via the web page connected by the communication network 106.

In another embodiment, when the user 220_{1-N} is Non-Resident Indian (NRI) then the user 220_{1-N} is required to upload country identification number and passport number to the server 212 via the web page connected by the communication network 106.

In yet another embodiment, when the user 220_{1-N} is Overseas Citizen of India (OCI) then the user 220_{1-N} is required to upload Overseas Citizen of India (OCI) number and passport number to the server 212 via the web page connected by the communication network 106.

In yet another embodiment, when the user 220_{1-N} is Person of Indian Origin (PIO) then the user 220_{1-N} is required to upload Person of Indian Origin (PIO) number and passport number to the server 212 via the web page connected by the communication network 106.

The method 400 proceeds to step 410. At step 410, listing of one or more properties for the property based transactions based on multiple property verification parameters. The types of information that can be exchanged include registration of the property for real estate transaction. Particularly, the information to be exchanged has to be registered. The user 220_{1-N} of the property who is an owner is able to select anyone of the options from being an individual, Sole proprietor, Pvt Ltd, one person company, public ltd, Nidhi company, section 8 (Not for profit company), Hindu undivided family, Partnership firm, Limited Liability Partnership, Unincorporated Association, body of individuals, body of individuals, trust and any other type of ownership.

In yet another embodiment of the present invention, when the user 220_{1-N} is an individual or a sole proprietor then the user 220_{1-N} is required to upload normal know your customer (KYC) documents or the sole proprietor documents (as the case maybe) to the server 212 via the web page connected by the communication network 106.

In yet another embodiment, when the user 220_{1-N} is any one of private limited company, one person company, public limited company, Nidhi Company, Section 8 (Not for Profit Company) subsequently, the user 220_{1-N} is required to upload cost to Company (CTC) board resolution for authorized signatory to the server 212 via the web page connected by the communication network 106.

In yet another embodiment of the present invention, when the user 220_{1-N} is Hindu Undivided Family (HUF) then the user 220_{1-N} is required to upload deed of declaration of Hindu Undivided Family (HUF), or PAN card in the name of the Karta and Bank Pass book, bank statement, Demat statement in the name of Hindu Undivided Family (HUF) to the server 212 via the web page connected by the communication network 106.

In yet another embodiment, when the user is a trust then the user 220_{1-N} is required to upload Cost to Company (CTC) Resolution of all the trustees for authorized signatory to the server 212 via the web page connected by the communication network 106.

In yet another embodiment, when the user is a partnership firm then the user 220_{1-N} is required to upload authorization letter of all partners for appointing authorized signatory, or know your customer (KYC) details as required of all partners to the server 212 via the web page connected by the communication network 106.

In yet another embodiment, when the user 220_{1-N} is a Limited Liability Partnership (LLP) then the user 220_{1-N} is required to upload Cost to Company (CTC) Resolution for authorized signatory to the server 212 via the web page connected by the communication network 106.

In yet another embodiment, when the user 220_{1-N} is an unincorporated association or body of individuals then the user 220_{1-N} is required to upload proof of existence/constitution document {resolution of the managing body & power of attorney granted to transact business on its behalf are mentioned currently); or authorization letter for appointment of authorized signatories to the server 212 via the web page connected by the communication network 106.

Particularly, the profiling of the properties can include supplying pictures of the property with the property profile. The financial data can include a transaction type the property seeker plans to use.

The method 400 proceeds at step 415. At step 415, drawing a freehand parameter contour on a property map displayed to the viewing user 220_{1-N}, by the user device 202₁ . . . 202_{N}, 208, 210. Particularly, the word “property map” refers to property location on a geographic map online using any available technology.

In one embodiment the user 220_{1-N} is a buyer. The user 220_{1-N} will search property based on the location entered by the user 220_{1-N} to the server 212 via the web page connected by the communication network 106. The user 220_{1-N} is able to select shape from the available options. Another option provided to the user 220 is the facility to draw the required shape on any map for example, google maps to mark the boundary of the area in which property is required. Furthermore, the property map refers to property location on a geographic map. Subsequently, the properties tagged under the selected area pop-up. The user 220_{1-N} also has alternate option to select shape. The user 220_{1-N} is able to set a centre point and select the radius. The properties under the circle with the selected center point and set radius will be shown. The nearby hospitals, railway/metro/bus/petrol station, schools/colleges, commercial complex, etc is also be illustrated on the map.

In another embodiment the user 220_{1-N} is a lessee. The user 220_{1-N} will search property based on the location entered by the user 220_{1-N} to the server 212 via the web page connected by the communication network 106. The user 220_{1-N} select shape from the available options and is able draw the required shape on any map for example, google maps to mark the boundary of the area in which property is required. The properties tagged under the selected area will pop-up. The user 220_{1-N} also has alternate option to select shape. The user 220_{1-N} can set a centre point and select the radius. The properties under the circle with the selected center point and set radius is viewed by the user. The nearby hospitals, railway/metro/bus/petrol station, schools/colleges, commercial complex, etc is illustrated on the available property map.

The method 400 proceeds to step 420. At step 420, automatically generating a geofence for the freehand parameter contour based on geographical location and popping multiple geofence properties based on tagging with a related address data field of listed multiple properties. In one embodiment the user 220_{1-N} is a buyer. The user 220_{1-N} is able search property based on the location entered by the user 220_{1-N} to the server 212 via the web page connected by the communication network 106. The user 220_{1-N} is able select shape from the available options and is able draw the required shape on google maps to mark the boundary of the area in which property is required. The properties tagged under the selected area are pop-up to the view user. The user 220_{1-N} also has alternate option to select shape.

In another embodiment, the user 220_{1-N} is able to set a centre point and select the radius on the property map in real time. Moreover, any new property added to the selected shape is illustrated to the user via the push notification as a new property added on the user device 202₁ . . . 202_{N}, 208, 210. The user 220_{1-N} with application installed in the cellphone with GPS on get a push notification every time the user enters an area where properties are tagged in the application.

In another embodiment, the user 220_{1-N} is able draw the free hand contour lines on the property map to construct any desired shape with any desired dimension. Moreover, the user is able to select a particular property area and subsequently latitude and longitude of the selected property area is stored in the database 127 in real time. Particularly, the user 220_{1-N} is able is zoom in or zoom out the details on the property map. In operation, the tagged particular property on the property map is retrieved using the stored latitude and longitude from the database 127.

In another embodiment the user 220_{1-N} is a lessee. The user 220_{1-N} search property based on the location entered by the user to the server 212 via the web page connected by the communication network 106. The user 220_{1-N} select shape from the available options and draw the required shape on the property map to mark the boundary of the area in which property is required and latitude and longitude of the selected property area is stored in the database 127 in real time. The properties tagged under the selected area pop-up. The user 220_{1-N} also has alternate option to select shape. The user 220_{1-N} can set a centre point and chose the radius. Any new property added to the selected shape is viewed as push notification as a new property added on the user device 202₁ . . . 202_{N}, 208, 210. The user 220_{1-N} with application installed in the cellphone with GPS on get a push notification every time he enters an area where properties are tagged in the application.

In one embodiment, the user is able draw any shape including but not limited to polyline, polygon, circle, rectangle and the like. Moreover, the user is able to use longitude and latitude markings from X1 to Y1 and to X2 to Y2. Further, the numerous properties coming under the drawn shape is highlighted to the user.

The method 400 proceeds to step 425. At step 425, one or more properties based on multiple property parameters retrieved from the database 127 of the server 212. Particularly, at step 425 a determination is made as to whether one or more properties match the information requested by the user device 202₁ . . . 202_{N}, 208, 210.

The method 400 proceeds to step 430. At step 430, selecting one or more property from the multiple properties by the user device 202₁ . . . 202_{N}, 208, 210 and legal verification of the selected one or more properties by receiving portions of a document image in an electronic form retrieved from a document database 127 of the server 212. Particularly, one or more property documents related to the real estate property is uploaded by the buyer or the lessor which is self declared by the user 220_{1-N}.

In one embodiment, the user is provided with the facility of online site visit. Particularly, the user is able to view the property in real time via a video module (not shown) of the server on the device interface of the user device. In operation, the video module is able to retrieve the data from one or more devices 202₁ . . . 202_{N}, 208, 210 from different locations in real time via the communication network 106. Moreover, view real estate properties through multiple different devices, such as a television (TV) set, mobile phone, personal computer, and/or personal digital assistant (PDA). In one implementation, the devices 202₁ . . . 202_{N}, 208, 210 may be connected to the multi-platform network 106 that stores real estate information in a central repository where appropriate listing information can be accessed by each type of device 202₁ . . . 202_{N}, 208, 210.

In another embodiment, the holographic display system (not shown) is employed in the present system. Particularly, the mobile holographic display system is positioned in the property site. Particularly, the multiple users situated at “X” locations view the property situated in “Y” location via the holographic display system.

The method 400 proceeds to step 435. At step 435, requesting, by the user device 202₁ . . . 202_{N}, 208, 210 to book transaction engine in the server 212 that is adapted to create in the encrypted virtual room to which one or more user devices 202₁ . . . 202_{N}, 208, 210 gains access for trading on the selected one or more properties via the interface.

In one embodiment, the method 400 further includes the step of artificial-intelligence based real-time segmentation of multiple properties based on zoning laws made by government and segmenting the multiple properties as residential, commercial, agricultural, and industrial and providing at least one chatbot as part of at least one messaging window at the webpage the chatbot adapted to assist the user in answering their concerns and problems based on available big data, and reviewing a response from the user using a combination of scripting and artificial intelligence. Particularly, the historical data is stored in a database and the historical data is used as benchmarking to find correct answers for every other queries of the user. Moreover, the collected and generated big data from several sources is data mined to suit multiple user requirements to take better decisions while trading in real estate.

The method 400 proceeds to step 440. At step 440, requesting, by the user device 202₁ . . . 202_{N}, 208, 210 via the transaction engine in the server 212 in the encrypted virtual room to which one or more user device 202₁ . . . 202_{N}, 208, 210 gains access for trading on the selected one or more properties via the interface selecting one or more bids from anyone of the auctions selected from forward auction, reverse auction and instant bid in real time. Particularly, the forward auction typically employed in buying and/or selling of real estate properties where sellers expects maximum return on his investment. Moreover, multiple buyers will participate and maximum value bid wins. However in leasing exclusive property gets the attention of many brands, and in many cases all of them want “X location”, and the lessor may opt for forward auction to get maximum returns on their rentals and can opt for the option of forward bidding.

In one embodiment, transparent holographic display system (not shown) is employed in the encrypted virtual room. Particularly, the transparent holographic display system is installed in a physical board room which is used for negotiating any particular real estate deal. Particularly, the multiple users situated at “X” locations collectively meet at “Y” location physical board room via the transparent holographic display system.

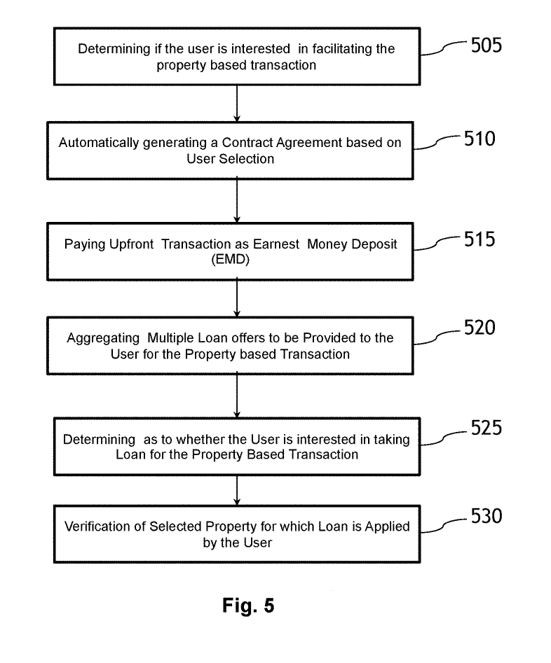

FIG. 5 is a flow diagram 500 of the method of facilitating property based transactions, according to further embodiment of the present invention. The method 500 starts at step 505 and proceeds to step 510. At Step 505, a determination is made as to whether the user 220_{1-N} is interested in the property based transaction.

In one embodiment if the determination is “NO” and the user 220_{1-N} is not interested in the property based transaction, the method 500 ends.

In another embodiment if the determination is “YES” and the user 220_{1-N} is interested in the property based transaction, the method 500 proceeds to 510. At step 510, a contract agreement is generated based on the user selection. The method 500 proceeds to step 515. At step 515, the user 220_{1-N} at the server end is provided with the option to open any account. Particularly, the present invention provides the option to open any account or escrow account to hold buyer's/lessor's deposit for buyer's contingent conditions and seller's/lessee's security deposit for possible property transaction. For these contingent conditions, once the real estate deal is confirmed by the user a pre-defined brokerage and/or consultancy fees is withdrawn from the buyer's/lessor's deposit and seller's/lessee's security deposit.

The method 500 proceeds to step 520. At step 520, the user 220_{1-N} is provided with multiple loan options. The user 220_{1-N} is able to view an aggregate of loan offers available at that point of time in real time to facilitate the process of property based transaction. The method 500 proceeds to step 525. At step 525, a determination is made as to whether the user 220_{1-N} is interested in taking loan and/or title insurance for the property based transaction.

In one embodiment, the title insurance, closing and escrow process attempts to make even the most complex transaction fit this ideal model where nothing is released to any party of the transaction until all obligations of all parties have been fulfilled.

In one embodiment if the determination is “NO” and the user is not interested in taking loan for the property based transaction, the method 500 ends.

In another embodiment if the determination is “YES” and the user is interested in the property based transaction, the method proceeds to step 530. At step 530, a verification of selected property for which loan and/or title insurance is applied by the user 220_{1-N} is carried out. Particularly, the parties to the real estate transaction (e.g., buyer, seller, lessor, lessee) must complete all requirements listed and agree to be subject to the exceptions listed in the contract agreement. Once all requirements have been met, the insurer then follows through with its contract agreement to issue the purchaser's/lessee's title insurance policy. If an adverse claim or challenge is made to the lien position, or ownership of an insured party a claim is made, the title insurer either will resolve the issue to restore the insured status, refund the loan amount under the purchaser's/lessee's title insurance policy, or refund the purchase price under the owner's title insurance policy to the insured.

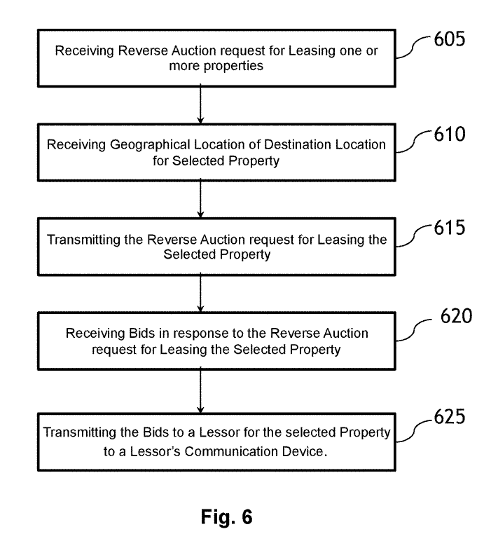

FIG. 6. is a flow diagram 600 of a method of receiving the reverse auction request for leasing the selected one or more properties from the user device 202₁ . . . 202_{N}, 208, 210 according to one embodiment of the present invention. The method 600 starts at step 605. At step 605, a request for leasing one or more properties by the user 220_{1-N} is received by the server 212 through the communication network 106. The method 600 proceeds to step 610. At step 610, geographical location of destination location for selected property is received by the server 212 through the communication network 106.

The method 600 proceeds to step 615. At step 615, the request for leasing the selected property is transmitted by the server 212 to the other users 220_{1-N} through the communication network 106. Once the leasing request for the selected property is viewed by the user 220_{1-N}, in turn provides a bid to the person responsible for selecting the party to whom the lease is finalized for the selected property. The method 600 proceeds to step 620. At step 620, multiple bids are received by the owner or the person responsible for leasing property in response to the reverse auction request. The method 600 proceeds to step 625. At step 625, transmission of the bids to the lessor for the selected property to the lessor's communication device based on the response of reverse auction request.

For example, the reverse auction request is typically used in leasing where a single brand makes a contour at X location on the property map. Further various property owners would like X brand to occupy the space, so the brand may opt for reverse bidding where all the participants provide their lowest rental value. In operation, the lowest bid is not compulsory to win the case, and the brand may select any option at the very moment.

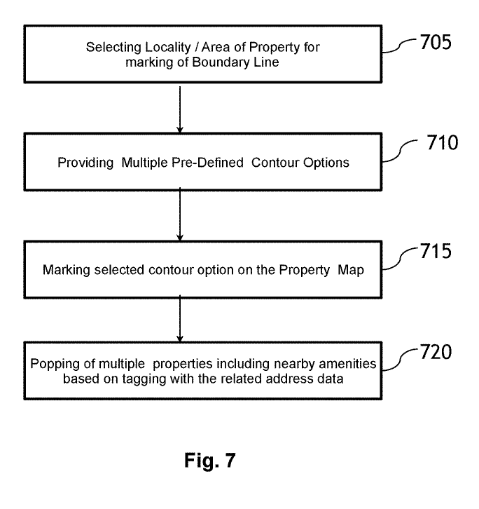

FIG. 7. is a flow diagram 700 of a method of drawing a freehand parameter contour on a property map displayed to the viewing user, according to one embodiment of the present invention. The method 700 starts at step 705. At step 705, the user for marking of boundary line on the property map. The method 700 proceeds to step 710. At step 710, multiple pre-defined contour options are provided to the user 220_{1-N} by the server 212 through the communication network 106. The method 700 proceeds to step 715. At step 715, the selected contour option by the user 220_{1-N} is marked on the property map. The method 700 proceeds to step 720. At step 720, popping of one or more properties along with nearby amenities based on tagging with a related address data field of listed the multiple properties. Particularly, multiple nearby amenities are one or more of nearby hospitals, Railway, Metro, Bus, petrol station, Schools, colleges, Commercial complex and the like.

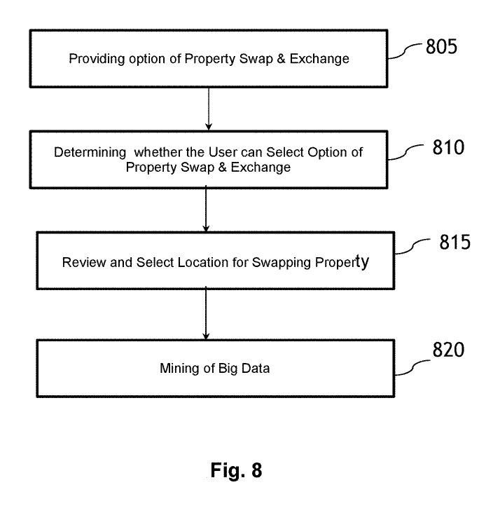

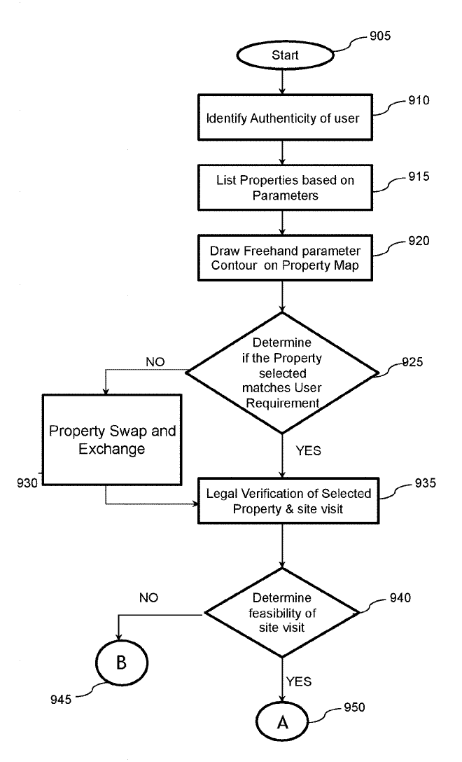

FIG. 8. is a flow diagram 800 of a method of providing option of property swap & exchange to the multiple users, according to one embodiment of the present invention. The method 800 starts at step 805. At step 805, the option of property swap & exchange is provided to the viewing user by the server 212 through the communication network 106. The method 800 proceeds to step 810. At step 810, a determination is made as to whether the viewing user 220_{1-N} selects option of property swap & exchange.

In one embodiment if the determination is “NO” and the user 220_{1-N} is not interested in swapping property, the method 800 ends.

In another embodiment if the determination is “YES” and the user 220_{1-N} is interested in swapping property, the method proceeds to 815. At step 815, reviewing multiple property location by the viewing user and selecting a location for swapping and exchange of available property location options matching a criteria selected by the user 220_{1-N} is provided. Particularly, if the instant bid fails, forward and reverse also fails, the user 220_{1-N} may swap his property with other properties retrieved from the database 127.

The method 800 starts at step 805 and proceeds to step 820. At step 820, the collected and generated big data from several sources is data mined to suit one or more user requirements to take better decisions while trading in real estate.

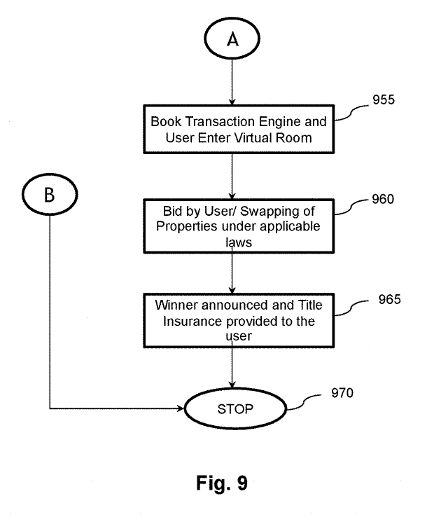

FIG. 9 is a flowchart illustrating a method 900 for facilitating property based transactions, according to one embodiment of the present invention. The method 900 starts at step 905 and proceeds to step 910. At step 910, the authenticity of the one or more viewing users 220_{1-N} is identified. Particularly, the web page is retrieved from the server 212 for display to the viewing user 220_{1-N} and the request for the retrieval of data is performed by the one or more user device 202₁ . . . 202_{N}, 208, 210. In operation, the viewing user 220_{1-N} is connected to a plurality of other users via a communication network 106.

In one embodiment, profiling of the viewing user 220_{1-N} to identify authenticity of the viewing user includes the steps of providing the dashboard with one or more dashboard items, reviewing a contract retrieved from the server on the user device 202₁ . . . 202_{N}, 208, 210, identifying type of registration, and providing authenticity documents for verification of the viewing user and storing the authenticity documents in the user database 127. Particularly, the type of registration is based for an individual or a business legal entity.

In one embodiment, profiling of the viewing user to identify authenticity is determined as to whether the viewing user is classified as Indian, OCI, PIO, NRI by checking validity of passport number and/or aadhar card number of the viewing user and self-attested copies of any one of passport, Overseas citizen of India (OCI) card, Country Identification number (CIN) and Persons of Indian Origin (PIO) card.

In one embodiment, the property verification parameters is any one of from a group includes nationality of property owner and the nationality of property owner is selected from Indian resident, NRI, OCI & PIO. Further, the property verification parameters is any one of review of one or more national database of government to determine legal validity and current ownership status of a particular property or a land parcel to determine benami transactions, pending payments, loan against property default, taxes to authority, and litigations pending against property in courts.

In one embodiment, transparent holographic display system (not shown) is employed to include a laser or other coherent light source, a lens, a transparent holographic display screen, storage for interference pattern features and an interference pattern reconstruction module. Particularly, the transparent holographic display system is used for online site visit where one user is situated at “X” location and the property is situated at “Y” location. The user situated at “X” location can view the “Y” location property via the implementation of transparent holographic display system including the online site visit and offline physical site visit.

FIG. 3 illustrates a block diagram 300 of another exemplary embodiment consistent with the present disclosure. Transparent holographic display system 102 is shown to include a laser or other coherent light source 302, a lens 304 a transparent holographic display screen 306, storage for interference pattern features 216 and an interference pattern reconstruction module 310.

The method 900 proceeds to step 915. At step 915, the listing of one or more properties for the property based transactions based on multiple property verification parameters. The method 900 proceeds to step 920. At step 920, drawing a freehand parameter contour on the property map displayed to the viewing user 220_{1-N} by the user device 202₁ . . . 202_{N}, 208, 210. In operation of step 920, geofence for the freehand parameter contour based on geographical location is automatically generated and popping of one or more geofence properties based on tagging with related address data field of listed multiple properties. Particularly by requesting the user device 202₁ . . . 202_{N}, 208, 210 and information from the server based on a one or more property parameters to create an interface to view the listing of the one or more geofence properties.

The method 900 proceeds to step 925. At step 925, a determination is made as to whether if the one or more properties selected by the user 220_{1-N} match the information requested by the user device 202₁ . . . 202_{N}, 208, 210. Particularly, multiple properties are retrieved from the database 127 based on one or more of property parameters stored in the server 212.

In one embodiment, if the determination is “NO” and the one or more properties selected by the user 220_{1-N} doesn't match the information requested by the user device 202₁ . . . 202_{N}, 208, 210. The method 900 proceeds to step 930. At step 930, viewing user 220_{1-N} is provided with the option of property swapping & exchanging from multiple properties. In operation of step 930, the viewing user 220_{1-N} is provided with property location by the viewing user 220_{1-N} and selecting a location for swapping and exchange. Particularly, multiple properties are reviewed from one or more of available property location options matching a criteria selected by the user 220_{1-N}. Particularly, the viewing user 220_{1-N} swaps one or more properties under applicable property laws. The method 900 proceeds to step 935.

In another embodiment, if the determination is “YES” and the one or more properties selected by the user 220_{1-N} match the information requested by the user device 202₁ . . . 202_{N}, 208, 210 the method 900 proceeds to step 935.

At step 935, the viewing user 220_{1-N} selects one or more property from the multiple properties by the user device 202₁ . . . 202_{N}, 208, 210 and legal verification of the selected one or more properties by receiving portions of a document image in an electronic form retrieved from a document database 127 of the server 212. Particularly, requesting by the user device 202₁ . . . 202_{N}, 208, 210 to schedule site visit of the selected one or more properties. Moreover, the user 220_{1-N} is provided with the property documents for verification purposes.

The method 900 proceeds to step 940. At step 940, determining feasibility of the site visit of the selected one or more properties based on multiple site visit parameters. Particularly, the site visit parameters is any one of the expectations already provided by the buyer or the lessee. In operation, the expectations should match the expectations of the seller or lessor and the like. The expectations for buying and/or selling scenario include payment time, loan against property, all dues cleared receipt and the like. For leasing it could be security deposit, lease tenure, lock in, escalation in rentals, furnished/unfurnished property and the like.

In one embodiment, if the determination is “NO” and the one or more properties selected by the user 220_{1-N} doesn't match the information requested by the user device 202₁ . . . 202_{N}, 208, 210. The method 900 proceeds to step 970.

In another embodiment, if the determination is “YES” at step 950 and the one or more properties selected by the user 220_{1-N} match the information requested by the user device 202₁ . . . 202_{N}, 208, 210.

The method 900 proceeds to step 955. The step 950 proceeds to step 955. At step 955, the user device 202₁ . . . 202_{N}, 208, 210 requests to book transaction engine in the server 212 which is adapted to create in the encrypted virtual room to which one or more user device 202₁ . . . 202_{N}, 208, 210 gains access for trading on the selected one or more property via the interface. Particularly, the transaction engine is configured to work on execution of a set of instructions which may include OTP generated password on the device 202₁ . . . 202_{N}, 208, 210 and/or any other encrypted and decrypted method for the transaction to happen.

The method 900 proceeds to step 960. At step 960, viewing user 220_{1-N} bids his by his user device 202₁ . . . 202_{N}, 208, 210. Particularly, one or more bid comprises computing and executing a valid higher bid for a forward auction, a lower bid of choice for a reverse auction, or an instant bid in real time that is within a programmed bid parameters stored on the server 212. In operation of step 960, a competitive bid has been made and accepted by the auction site that is higher for the forward auction or lower for the reverse auction than the most recent bid determined by one or more bidding virtual agent. The method 900, proceeds to step 965, announcing winner of the transaction and providing loan and/or title insurance to the user 220_{1-N} based on programmed transaction parameters.

In another embodiment, the user is able to swap properties under applicable laws.

In another embodiment, the method 900 further includes the step of property verifying a cryptographic transaction involving an exchange of cryptocurrency. In operation, the cryptographic processor is operably in communication a cryptographic storage medium having stored thereon computer-executable code stored thereon, that when executed by the cryptographic processor performs identifying a cryptographic transaction involving an exchange of a cryptographic currency key, requesting a portion of the blockchain, verifying a value of the cryptocurrency key using payment verification and payment is submitted through one or more user addresses according to blockchain. The method 900, proceeds to final step 970. At step 970, the method 900 ends.

Therefore, as may be seen, various embodiments of the present invention, as herein described above, provide several advantages, such as, for example, but not limited to, fair valuation of the property and a transparent mechanism to sell, buy or lease a real estate property. Moreover, various embodiments of the present invention are aimed at providing buying, selling, leasing services under normal auction transaction model with significant improvements over prior art, and leasing services under reverse auction transaction model with significant improvements over prior art.

Further, there is no agent or broker in the present system and the present method and system is directly given to the authorized signatory who wants to transact for a particular property. Sanctity and genuineness of the client is not shown through agents representing their client. The virtual room is a private room without disclosing the identity of the client to make things fair for everyone in the market. The data transmitted is encrypted. Furthermore, the present invention provides an opportunity to the users to chat or talk with each other without disclosing their identity. In the present invention, bid raising section and bid history table is removed after the bid is complete. Instead of bid history, the cost of the property on sale along with the buyer or seller's expectation and lessee or lessor's expectation is illustrated. The active user count is also removed eventually. The present invention provides an option of negotiation price bar where the buyer and/or lessor negotiates the cost of the property with the seller and/or lessee. Also the negotiation cost entered by the buyer and/or lessor is removed after the seller and/or lessor approves or rejects the negotiation cost.

I claim:

1. A method for facilitating property based transactions, said method comprising the steps of:
requesting, by a user device, a web page from a server for display to a viewing user, wherein:
profiling of said viewing user to identify authenticity of said viewing user and said viewing user connected to a plurality of other users via a communication network;
listing of a plurality of properties for said property based transactions based on a plurality of property verification parameters;
drawing a freehand parameter contour on a property map displayed to said viewing user, by said user device;
automatically generating a geofence for said freehand parameter contour based on geographical location and popping a plurality of geofence properties based on tagging with a related address data field of listed said plurality of properties;
requesting, by said user device, information from said server based on a plurality of property parameters to create an interface to view said listing of said plurality of geofence properties;
retrieving said plurality of properties based on said plurality of property parameters;
determining as to whether said plurality of properties match said information requested by said user device;
selecting at least one property from said plurality of properties by said user device and legal verification of said selected at least one property by receiving portions of a document image in an electronic form retrieved from a document database of said server;
requesting, by said user device, to schedule site visit of said selected at least one property;
determining as to whether site visit of said selected at least one property feasible based on a plurality of site visit parameters;
requesting, by said user device, to book transaction engine in said server that is adapted to create in an encrypted virtual room to which at least one user device gains access for trading on said selected at least one property via said interface;
wherein at least one bid comprises computing and executing a valid higher bid for a forward auction, a lower bid of choice for a reverse auction, or an instant bid in real time that is within a programmed bid parameters, if a competitive bid has been made and accepted by the auction site that is higher for the forward auction or lower for the reverse auction than the most recent bid determined by at least one bidding virtual agent.

2. A method as claimed in claim 1, wherein said method further comprises the steps of: determining as to whether said user is interested in facilitating said property based transaction; generating a contract agreement automatically based on user selection; paying upfront transaction as earnest money deposit (EMD); aggregating anyone of a plurality of loan offers to be provided to said user for said property based transaction and a title insurance for the property based transaction; determining as to whether said user is interested in taking loan for said property based transaction and said title insurance; and verification of selected property for which loan is applied by said user.

3. A method as claimed in claim 1, wherein said step of receiving said reverse auction request for leasing said selected at least one property from said user device comprises:
receiving, from said user device, geographical location information of a destination location for said reverse auction request for leasing said selected at least one property;
transmitting said reverse auction request for leasing said selected at least one property;
receiving bids in response to said reverse auction request for leasing said selected at least one property; and
transmitting said bids to a lessor of said selected at least one property to a lessor communication device.

4. The method of claim 1, wherein profiling of said viewing user to identify authenticity of said viewing user comprises the steps of: providing a dashboard with one or more dashboard items; reviewing a contract retrieved from said server on said user device; identifying type of registration; and providing authenticity documents for verification of said viewing user and storing said authenticity documents in a user database; wherein said type of registration is based for an individual or a business legal entity.

5. A method as claimed in claim 1, wherein profiling of said viewing user to identify authenticity is determined as to whether said viewing user is classified as Indian, OCT, PIO, NRI by checking validity of passport number and/or aadhar card number of said viewing user and self-attested copies of any one of passport, Overseas citizen of India (OCI) card, Country Identification number (CIN) and Persons of Indian Origin (PIO) card.

6. A method as claimed in claim 1, wherein said plurality of property verification parameters is any one of from a group comprising nationality of property owner and said nationality of property owner is selected from Indian resident, NRI, OCI & PIO and wherein said plurality of property verification parameters is any one of review of one or more national database of government to determine legal validity and current ownership status of a particular property or a land parcel to determine benami transactions, pending payments, loan against property default, taxes to authority, and litigations pending against property in courts.

7. A method as claimed in claim 1, wherein said plurality of site visit parameters is any one of payment time, loan against property, all dues cleared receipt, security deposit, lease tenure, lock in, escalation in rentals, furnished property, unfurnished property and the like.

8. A method as claimed in claim 1, wherein said drawing a freehand parameter contour on a property map displayed to said viewing user comprises the steps of selecting preferred locality of property for marking of boundary line on said property map; providing a plurality of pre-defined contour options and marking selected contour option on said property map; generating latitude and longitude of said selected contour option on said property map and storing said generated latitude and longitude in said database; popping a plurality of properties along with nearbuy amenities based on tagging with a related address data field of listed said plurality of properties; wherein said plurality of nearbuy amenities is anyone of nearby hospitals, Railway, Metro, Bus, petrol station, Schools, colleges, Commercial complex and the like.

9. A method as claimed in claim 8, wherein said viewing user select a centre point and a radius on said property map, and draw any shape comprising polyline, polygon, circle, rectangle and the like and a plurality of properties under said selected radius is displayed to said viewing user.

10. A method as claimed in claim 8, wherein said method further comprises the step of providing to said user by one or more of IM, text, or push notification on an app for new property added to said selected contour on said property map and providing push notification on said app to said user every time said user enters an area of said selected contour.

11. A method as claimed in claim 8, wherein said method further comprises the step of artificial-intelligence based real-time segmentation of said plurality of properties based on zoning laws made by government and segmenting said plurality of properties as residential, commercial, agricultural, and industrial and providing at least one chatbot as part of at least one messaging window at said webpage said chatbot adapted to assist said user in answering their concerns and problems based on available big data; and reviewing a response from said user using a combination of scripting and artificial intelligence; wherein historical data is stored in a database and said historical data is used as benchmarking to find correct answers for every other queries of said user.

12. A method as claimed in claim 1, wherein said method further comprises the step of property verifying a cryptographic transaction involving an exchange of cryptocurrency, said method comprising: at a cryptographic processor operably in communication a cryptographic storage medium having stored thereon computer-executable code stored thereon, that when executed by the cryptographic processor performs: identifying a cryptographic transaction involving an exchange of a cryptographic currency key; requesting a portion of the blockchain; verifying a value of said cryptocurrency key using payment verification and payment is submitted through one or more user addresses according to blockchain.

13. A method as claimed in claim 1, wherein said method further comprises the step of:
providing option of property swap & exchange of said plurality of properties to said viewing user; determining whether said viewing user select option of property swap & exchange; providing property location by said viewing user and selecting a location for swapping and exchange; and reviewing a plurality of available property location options matching a criteria selected by said user; wherein collected and generated big data from several sources is data mined to suit a plurality of user requirements to take better decisions while trading in real estate.

14. A method as claimed in claim 2, wherein said at least one bid comprises computing and executing a valid higher bid for said forward auction further comprise the step of providing said at least one bid by a buyer and progress bar to be updated as time progress in real time, wherein said buyer is able to view a current max bid, a highest bid by each buyer, and previous bidding bid status.

15. A system for facilitating property based transactions and preloading said property content performed by an apparatus for displaying a plurality of property content on a local handheld device, said system comprising:
a display unit, a display region variation determining unit, a preloading controller, and a preloading performing unit, including a display region of said plurality of properties, wherein said displaying is performed by said display unit with a preloading an application in a memory of a mobile computing device based on data stored in a remote server;
one or more processors; and one or more computer-readable media having stored thereon instructions that are executable by said one or more processors to configure said system to display said plurality of properties, including instructions that are executable to configure said system to perform at least the following:
profiling of said viewing user to identify authenticity of said viewing user and said viewing user connected to a plurality of other users via a communication network; listing of a plurality of properties for said property based transactions based on a plurality of property verification parameters; drawing a freehand parameter contour on a property map displayed to said viewing user, by said user device; automatically generating a geofence for said freehand parameter contour based on geographical location and popping a plurality of geofence properties based on tagging with a related address data field of listed said plurality of properties;
requesting, by said user device; information from said server based on a plurality of property parameters to create an interface to view said listing of said plurality of geofence properties;
retrieving said plurality of properties based on said plurality of property parameters;
determining as to whether said plurality of properties match said information requested by said user device;
selecting at least one property from said plurality of properties by said user device and legal verification of said selected at least one property by receiving portions of a document image in an electronic form retrieved from a document database of said server;
requesting, by said user device, to schedule site visit of said selected at least one property;
determining as to whether site visit of said selected at least one property feasible based on a plurality of site visit parameters;
requesting, by said user device, to book a transaction engine in said server that is adapted to create in an encrypted virtual room to which at least one user device gains access for trading on said selected at least one property via said interface;
wherein at least one bid comprises computing and executing a valid higher bid for a forward auction, a lower bid of choice for a reverse auction, or an instant bid in real time that is within a programmed bid parameters; if a competitive bid has been made and accepted by the auction site that is higher for the forward auction or lower for the reverse auction than the most recent bid determined by at least one bidding virtual agent.

16. The system as claimed in claim 15, wherein said one or more processors; and one or more computer-readable media having stored thereon instructions that are executable by said one or more processors to configure said system to display said plurality of properties, including instructions that are executable to configure said system to perform profiling of said viewing user to identify authenticity of said viewing user comprises the steps of: providing a dashboard with one or more dashboard items; reviewing a contract retrieved from said server on said user device; identifying type of registration; and providing authenticity documents for verification of said viewing user and storing said authenticity documents in a user database; wherein said type of registration is based for an individual or a business legal entity.

17. The system as claimed in claim 15, wherein profiling of said viewing user to identify authenticity is determined as to whether said viewing user is classified as Indian, NRI OCI, PIO, by checking validity of passport number and/or aadhar card number of said viewing user and self-attested copies of any one of passport, Overseas citizen of India (OCI) card, Country Identification number (CIN) and Persons of Indian Origin (PIO) card.

18. The system as claimed in claim 15, wherein said plurality of property verification parameters is any one of from a group comprising nationality of property owner and said nationality of property owner is selected from Indian resident, NRI, OCI & PIO.

19. The system as claimed in claim 15, wherein said plurality of property verification parameters is any one of review of one or more national database of government to determine legal validity and current ownership status of a particular property or a land parcel to determine benami transactions, pending payments, loan against property default, taxes to authority, and litigations pending against property in courts.

20. The system as claimed in claim 15, wherein a contour module of said system execute a set of instructions to draw a freehand parameter contour on a property map displayed to said viewing user comprises the steps of: selecting preferred locality of property for marking of boundary line on said property map; providing a plurality of pre-defined contour options and marking selected contour option on said property map; generating latitude and longitude of said selected contour option on said property map and storing said generated latitude and longitude in said database; popping a plurality of properties along with nearby amenities based on tagging with a related address data field of listed said plurality of properties; wherein said plurality of properties along with nearby)/amenities is anyone of nearby hospitals, Railway, Metro, Bus, petrol station, Schools, colleges, Commercial complex and the like.
